(19) United States
(12) Patent Application Publication
(10) Pub. No.: US 2015/0269574 A1
(43) Pub. Date: Sep. 24, 2015

(54) PASSWORD KEY, SECURITY AUTHENTICATION SYSTEM AND SECURITY AUTHENTICATION METHOD

(71) Applicant: NATIONZ TECHNOLOGIES INC., Shenzhen City, Guangdong (CN)

(72) Inventors: Juan Peng, Shenzhen (CN); Xiaokun Zou, Shenzhen (CN); Yiwei Zhang, Shenzhen (CN); Jie Liang, Shenzhen (CN); Yunbo Yu, Shenzhen (CN)

(21) Appl. No.: 14/437,603

(22) PCT Filed: Oct. 14, 2013
(86) PCT No.: PCT/CN2013/085152

§ 371 Date: Apr. 22, 2015

(30) Foreign Application Priority Data
Oct. 23, 2012 (CN) 201210406260.X

(51) Int. Cl. G06Q 20/40; H04L 29/08

(52) U.S. Cl. CPC G06Q 20/401; H04L 67/02; G06Q 2220/12

(57) ABSTRACT

An encryption key, a security authentication system and a security authentication method. The encryption key comprises a security module, a first control unit, a first oscillation transmission unit and a first oscillation receiving unit. The first oscillation receiving unit receives as input an oscillation signal transmitted through medium. The first oscillation transmission unit transmits output encryption information to the medium. The input of the first control unit is connected to the output of the first oscillation receiving unit; the control port of the first control unit is connected to the security module; and the output of the first control unit is connected to the input of the first oscillation transmission unit. Encryption information is transmitted wirelessly by the oscillation of the medium the encryption key resides in. Encryption information is transmitted between the encryption key and the mobile terminal by the oscillation of the medium without public network's intervention.

### CROSS-REFERENCE TO RELATED APPLICATIONS

This application is a United States National Stage Application of International Patent Application No. PCT/CN2013/085152, filed on Oct. 14, 2013, which claims the benefit of Chinese Patent Application No. 201210406260.X, filed on Oct. 23, 2012, the entire contents of which are incorporated herein in their entirety by reference.

### BACKGROUND

1. Field of the Disclosure

The present disclosure relates to security authentication, and in particular to an encryption key, a security authentication system and a security authentication method.

2. Relevant Background

With the development of a computer network, a handheld device, etc., online payment is increasingly popular. In order to solve the security issue of online payment, security encryption keys, such as USB keys, have been used to ensure the safety of online transactions.

Currently, along with the popularity of personal handheld terminal and wireless network, the client transaction interface platform gradually migrates to handheld terminals. Handheld terminal using USBKey or TF-Key for contact or payment identity authentication often needs contact interface, a scarce resource that is difficult to extend.

For telecommunication operation network (such as Wifi or 3G) based wireless encryption key, identity authentication data will be exposed to public networks and the possibility of being attacked greatly increases.

### SUMMARY

The present disclosure discloses an encryption key, which comprises a security module, a first control unit, a first oscillation transmission unit and a first oscillation receiving unit. The first oscillation receiving unit is used to receive an oscillation signal transmitted through medium. The first oscillation transmission unit is used to transmit encryption information to the medium. The first control unit is connected to the first oscillation receiving unit, the security module and the first oscillation transmission unit. After processing the oscillation signal received by the first oscillation receiving unit, the first control unit transmits the obtained payment information to the security module; the security module outputs the payment information after encrypting; the signal, which is obtained by the first control unit decrypting the output of the security module, is transmitted to the medium by the first oscillation transmission unit.

Further, the security module comprises a security chip, a storage device, and an identity authentication management module. The security chip is connected to the first control unit and is used to acquire signature data and generate a control signal according to the signature data. The storage device is connected to the security chip and is used to store the signature data acquired by the security chip and provide required signature data for verifying. The identity authentication management module is connected to the first control unit and is used to manage the identity of the legitimate user of a mobile terminal and identify a user's identity when the user is conducting a transaction.

Further, the first control unit comprises a controller, which is used to provide an interface connected to the security chip of the security module, analyze and respond to the control signal generated by the security chip, and control and process the transmitted and received information.

Further, the first oscillation transmission unit comprises an oscillation source, which outputs oscillation wave under the control of the first control unit.

Further, the first oscillation receiving unit comprises a sensor and a signal processing unit, which are connected to each other in sequence. The sensor is used to detect and receive the oscillation signal transmitted in the medium, and the signal processing unit is used to output a digital signal after processing the oscillation signal.

Further, the signal processing unit comprises an A/D converter, a demodulator, a low pass filter, and a decoder, which are connected in sequence. The A/D converter is used to convert the oscillation signal transmitted in the medium and received by the sensor to a corresponding digital signal. The demodulator is used to demodulate the digital signal output by the A/D converter. The low pass filter is used to filter the output of the demodulator and acquire the non-decoded baseband digital signal. The decoder outputs a digital signal after processing the baseband digital signal output from the low pass filter.

Further, the oscillation signal is transmitted in the medium in the form of mechanical wave.

Further, the medium is anyone of liquid, solid, and air.

The present disclosure further provides a security authentication system, which comprises an encryption key and a mobile terminal, between which a signal is transmitted by medium oscillation. The encryption key comprises a security module, a first control unit, a first oscillation transmission unit and a first oscillation receiving unit. The first oscillation receiving unit is used to receive an oscillation signal transmitted through medium. The first oscillation transmission unit is used to transmit encryption information to the medium. The first control unit is connected to the first oscillation receiving unit, the security module and the first oscillation transmission unit. After processing the oscillation signal received by the first oscillation receiving unit, the first control unit transmits the obtained payment information to the security module; the security module outputs the payment information after encrypting; the encryption information, which is obtained by the first control unit decrypting the output of the security module, is transmitted to the medium by the first oscillation transmission unit. The mobile terminal comprises a second control unit, a second oscillation receiving unit and a second oscillation transmission unit connected to the second control unit respectively. Signals are transmitted between the second oscillation receiving unit and the first oscillation transmission unit by medium oscillation; signals are transmitted between the second transmission unit and the first oscillation receiving unit by medium oscillation. The second control unit processes the payment information to an oscillation signal, and transmits the oscillation signal to the medium by the second oscillation transmission unit; the second oscillation receiving unit receives the encryption information transmitted by the first oscillation transmission unit; the encryption key and the mobile terminal complete the encryption information transmission procedure in the medium after the second control unit processes the encryption information.

Further, the mobile terminal is a cellphone or a PC.

Further, the oscillation signal is transmitted in the medium in the form of mechanical wave.

Further, the medium is anyone of liquid, solid, and air.

The present disclosure also provides a security authentication method, which comprises the following steps:

S1: after an encryption key is authenticated, a mobile terminal oscillates and initiates a request for receiving payment information;

S2: a second control unit in the mobile terminal obtains an oscillation signal after receiving and processing a payment information instruction;

S3: a second oscillation transmission unit in the mobile terminal outputs the oscillation signal to the medium it resides in by oscillation;

S4: a first oscillation receiving unit in the encryption key receives the oscillation signal in the medium;

S5: a first control unit in the encryption key processes the oscillation signal and then transmits the obtained payment information to the security module; the security module outputs the payment information after encrypting.

S6: after decrypting the information output from the security module, the first control unit in the encryption key feeds back the obtained encryption information to a first oscillation transmission unit for outputting it to the medium by oscillation;

S7: a second oscillation receiving unit in the mobile terminal receives the encryption information returned from the first oscillation transmission unit and outputs it to the second control unit;

S8: the second control unit in the mobile terminal converts the received encryption information to the requested payment information.

Further, in step S3, the signal generated by oscillation is generally transmitted in the medium in the form of mechanical wave; the mechanical wave is an acoustic wave with a frequency of 20 Hz-20 KHz or is an ultrasonic wave with a frequency greater than 20 KHz.

Further, the medium is anyone of liquid, solid, and air.

Further, the mobile terminal is a cellphone or a PC.

In the security authentication method provided in this disclosure, the oscillation of the medium that the encryption key resides in is used for wireless transmission of encryption information, so as to solve the problems of scarce interface resources in a handheld terminal and mismatch between a handheld terminal and an encryption key interface, etc. Meanwhile, the encryption key can transmit information without a network. The transmission channel is not a common channel and thus the security problem of a common wireless encryption key is solved.

### BRIEF DESCRIPTION OF THE DRAWINGS

FIG. 1 is a block diagram of internal modules of an encryption key and a mobile terminal according to an implementation of the present disclosure.

FIG. 2 is a block diagram of internal modules in a security module of an encryption key according to an implementation of the present disclosure.

FIG. 3 is a diagram of a first oscillation transmission unit in an encryption key according to an implementation of the present disclosure.

FIG. 4 is a diagram of a first oscillation receiving unit in an encryption key according to an implementation of the present disclosure.

FIG. 5 is a block diagram of internal modules of a signal processing unit in a first oscillation receiving unit according to an implementation of the present disclosure.

FIG. 6 is an implementation flow chart of the security authentication method according to an implementation of the present disclosure.

### DETAILED DESCRIPTION

The technical solutions and the advantages of the present disclosure will be further described in detail as follows in combination with the accompany drawings and implementations. It is appreciated that the specific implementations or embodiments described herein are intended to interpret the present disclosure only but not intended to limit the present disclosure.

The present disclosure provides an encryption key. The encryption key can transmit information by means of oscillation of liquid, solid and air, using the oscillation of the medium it resides in for wirelessly transmitting encryption information, so as to solve the problems of scarce interface resources in a handheld terminal and mismatch between a handheld terminal and an encryption key interface, etc. Furthermore, since the transmission channel is not a common channel, the security problem of a common wireless encryption key is solved.

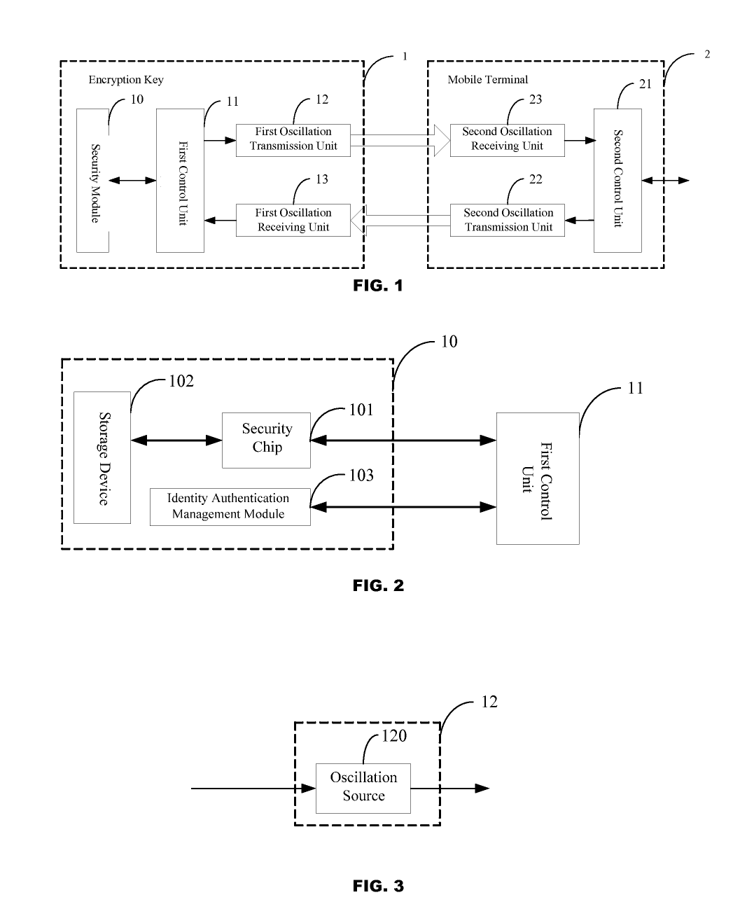

FIG. 1 shows a block diagram of internal modules of an encryption key according to an implementation of the present disclosure. For convenience of description, parts that are only related to the implementation of the present disclosure are described as follows.

An encryption key 1 comprises a security module 10, a first control unit 11, a first oscillation transmission unit 12, and a first oscillation receiving unit 13. The input of the first oscillation receiving unit 13 is used to receive an oscillation signal transmitted in the medium. The output of the first oscillation transmission unit 12 is used to transmit encryption information to the medium. The input of the first control unit 11 is connected to the output of the first oscillation receiving unit 13. The control port of the first control unit 11 is connected to the security module 10. The output of the first control unit 11 is connected to the input of the first oscillation transmission unit 12. The first oscillation receiving unit 13 transmits the received oscillation signal to the first control unit 11. The first control unit 11 then transmits the oscillation signal to the security module 10 after processing. The security module 10 transmits payment information to the first control unit 11 after processing. The first control unit 11 then transmits it to the first oscillation transmission unit 12 after processing. The first oscillation transmission unit 12 transmits this signal to the medium.

As illustrated in FIG. 2, the security module 10 is used to process the information required to be transmitted to a mobile terminal. The security module 10 comprises a security chip 101, a storage device 102, and an identity authentication management module 103. The security chip 101 is connected to the first control unit 11 to acquire the signature data and generates a control signal according to the signature data. The storage device 102 is connected to the security chip 101 to store the signature data acquired by the security chip 101 and to provide the signature data to the security chip 101 for verifying. The identity authentication management module 103 is connected to the first control unit 11, for managing the identity of the legitimate user of the mobile terminal and identifying a user's identity when the user is conducting a transaction.

The first control unit 11 is used to transform the information processed by the security module 10 to a signal to be sent by the first oscillation transmission unit 12. The first control unit 11 comprises a controller, which is used to provide an interface to the security chip 101 of the security module 10, analyze and respond to the control signal generated by the security chip 101, and control and process the transmitted and received information.

An implementation of this disclosure further comprises a battery (not shown in the Figure) supplying power to the encryption key for normal operation. Compared with existing encryption key (for example, USBKey, etc.), some elements need to be added to the encryption key in this disclosure, which transmits information by means of oscillation of liquid, solid and air. With the development of the mobile terminal and the encryption key, the demand for convenience and safety is more and more increasing. Related encryption key can be specially made according to the technology in this disclosure, so that universality and security can be achieved when people use mobile terminals for real-time online payment in daily life.

As illustrated in FIG. 3, the first oscillation transmission unit 12 comprises an oscillation source 120, which outputs oscillation wave under the control of the first control unit 11. The oscillation source 120 can be a mechanical oscillation source, and the oscillation wave can be mechanical wave.

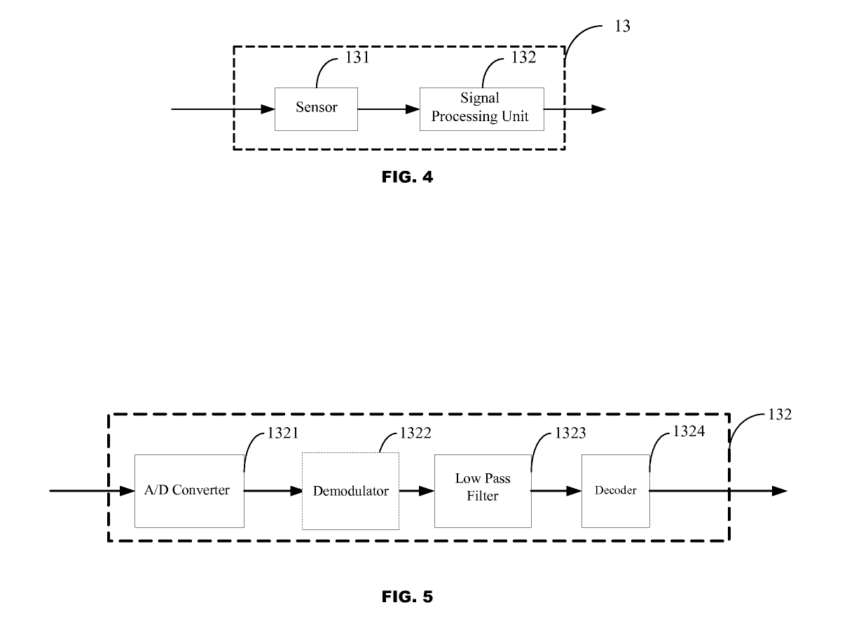

As illustrated in FIG. 4, the first oscillation receiving unit 13 comprises a sensor 131 and a signal processing unit 132, which are connected to each other in sequence. The sensor 131 is used to detect and receive an oscillation signal transmitted in the medium, and the signal processing unit 132 is used to output a digital signal after processing the oscillation signal. The sensor 131 can be a MEMS sensor.

As illustrated in FIG. 5, the signal processing unit 132 comprises an A/D converter 1321, a demodulator 1322, a low pass filter 1323, and a decoder 1324, which are connected in sequence. The input of the A/D converter 1321 is connected to the output of the sensor 131 and the output of the A/D converter 1321 is connected to the input of the demodulator 1322 for converting the analog signal received by the sensor 131 to a corresponding digital signal. The output of the demodulator 1322 is connected to input of the low pass filter 1323 for demodulating the digital signal. The output of the low pass filter 1323 is connected to the input of the decoder 1324 for acquiring the non-decoded baseband digital signal. The output of the decoder 1324 outputs the digital signal.

In an implementation of this disclosure, encryption information is transmitted wirelessly by the oscillation of the medium the encryption key resides in, so there is mismatch between the encryption key and a handheld terminal's interface. The encryption information is transmitted by the oscillation of the medium (e.g., liquid, solid or air) between the encryption key and a handheld terminal without public network's intervention, so that the system's security is improved.

In an implementation of this disclosure, the aforementioned encryption key can combined with a mobile terminal to form a security authentication system. As illustrated in FIG. 1, the security authentication system comprises the encryption key 1 and the mobile terminal 2. A signal is transmitted between the encryption key 1 and the mobile terminal 2 by the medium oscillation. The medium can be liquid, solid, air, etc. The mobile terminal can be a cellphone or a PC.

The mobile terminal 2 comprises a second control unit 21, a second oscillation receiving unit 23 connected to the output of the second control unit 21, and a second oscillation transmission unit 22 connected to the input of the second control unit 21. The input of the second oscillation receiving unit 23 and the output of the first oscillation transmission unit 12 in the encryption key 1 transmit a signal by medium oscillation. The output of the second oscillation transmission unit 22 and the input of the first oscillation receiving unit 13 in the encryption key 1 transmit the signal by medium oscillation. The second oscillation receiving unit 23 in the mobile terminal 2, after receiving the signal, transmits the signal to the second control unit 21 for processing, so that the encryption key 1 and the mobile terminal 2 complete the encryption information transmission procedure in medium. The second control unit 21 processes the payment information to be a signal and sends the payment information to the encryption key to control the oscillation transmission unit and the oscillation receiving unit.

In an implementation of this disclosure, the mobile terminal 2 transforms the payment information to an oscillation signal (e.g., mechanical wave) by the second control unit 21 and the second oscillation transmission unit 22 and transmits the signal. The first oscillation receiving unit 13 in the encryption key 1 receives the signal and transmits it to the first control unit 11. The first control unit 11 then transmits it to the security module 10 after processing. The security module 10 transmits the payment information to the first control unit 11 after processing. The first control unit 11 transmits the signal to the first oscillation transmission unit 12. The first oscillation transmission unit 12 then transmits the signal to the medium. After receiving the signal, the second oscillation receiving unit 23 in the mobile terminal 2 transmits it to the second control unit 21 for processing, so that the encryption key 1 and the mobile terminal 2 complete the encryption information transmission procedure in medium.

In an implementation of this disclosure, security authentication is described in the following operation flow:
(1) The mobile terminal 2 approaches to the encryption key 1 and authenticate the encryption key 1; after authentication is verified, the mobile terminal 2 oscillates and initiates the request for receiving payment information;
(2) The second control unit 21 in the mobile terminal 2 receives an instruction and processes this signal;
(3) The second oscillation transmission unit 22 in the mobile terminal 2 outputs the signal to the medium it resides in by oscillation;
(4) The encryption key 1 receives the signal in the medium by the sensor 131 in the first oscillation receiving unit 13;
(5) The first control unit 11 in the encryption key 1 processes the received signal and then transmits to the security module 10; the security module 10 processes the payment information requested by the mobile terminal;
(6) The first control unit 11 in the encryption key 1 processes the information from the security module 10, feeds back it to the first oscillation transmission unit 12 and outputs the signal to the medium by oscillation.
(7) The sensor of the second oscillation receiving unit 23 in mobile terminal 2 receives the data information returned from the encryption key 1.
(8) The second control unit 21 in the mobile terminal 2 processes the received data information and converts it to the requested payment information.

In an implementation of this disclosure, the security authentication system wirelessly transmits encryption information by the oscillation of medium in which the encryption key 1 resides. The encryption information is transmitted by the oscillation of the medium (e.g., liquid, solid and air) between the encryption key 1 and the mobile terminal 2 without public network's intervention, so that the possibility of an attacker stealing information to crack passwords substantively decreases. Compared with the information transmission transaction technology between an encryption key (for example, USBKey etc.) and a mobile terminal, the encryption key transmits information by the oscillation of the medium. The universality is better and user experience is great.

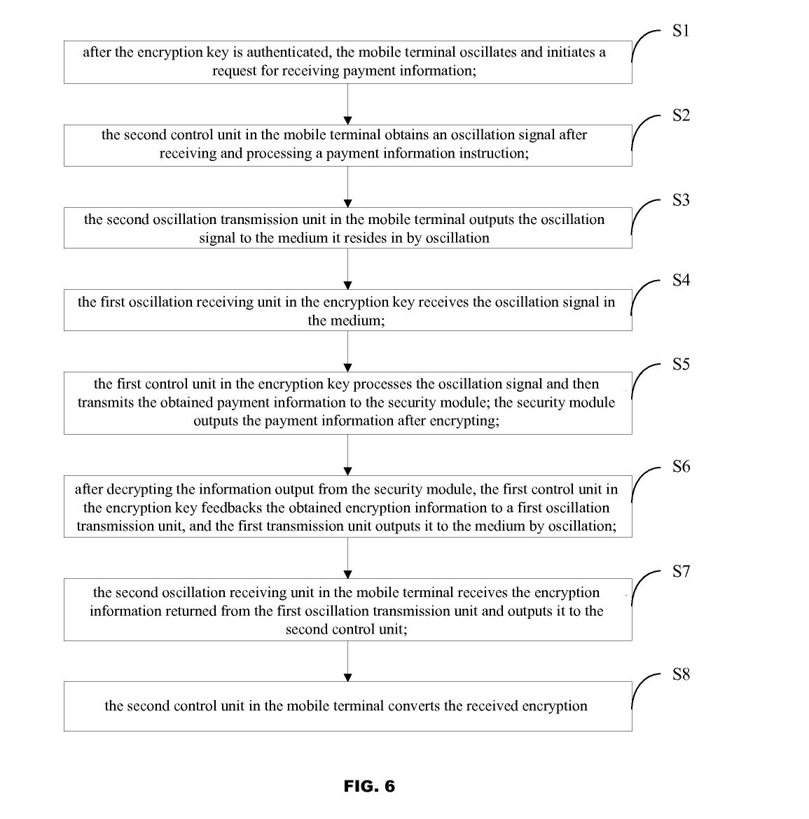

FIG. 6 shows an implementation flow chart of the security authentication method according to an implementation of the present disclosure, which comprises the following steps.

S1: after the encryption key is authenticated, the mobile terminal oscillates and initiates a request for receiving payment information;

S2: the second control port in the mobile terminal receives a payment information instruction and processes this instruction signal;

S3: the second oscillation transmission unit in the mobile terminal outputs the signal to the medium it resides in by oscillation; the signal generated by oscillation generally is transmitted in the medium in the form of the mechanical wave; for example, the mechanical wave can be an acoustic wave with ear recognition frequency (20Hz˜20 KHz) and can also be an ultrasonic wave with frequency greater than 20 KHz, and so on;

S4: the first oscillation receiving unit in the encryption key receives the signal in the medium; there is neither an interface nor a network connecting between the encryption key and the mobile terminal, and the encryption key and the mobile terminal transmit information directly by oscillation;

S5: the first control unit in the encryption key processes the received signal and then transmits to the security module; the security module processes the payment information requested by the mobile terminal;

S6: the first control unit in the encryption key processes the information output from the security module, feeds back it to the first oscillation transmission unit and outputs the signal to the medium by oscillation;

S7: the second oscillation receiving unit in mobile terminal receives the data information returned from the first oscillation transmission unit in the encryption key;

S8: the second control unit in the mobile terminal processes the received data information and transforms it to the requested payment information.

In the security authentication method provided in this disclosure, the oscillation of the medium the encryption key resides in is used for wirelessly transmitting encryption information, so as to solve the problems of scarce interface resources in a handheld terminal and mismatch between a handheld terminal and an encryption key interface, etc. Furthermore, the encryption key can transmit information without a network. The transmission channel is not a common channel, solving a common wireless encryption key's security problem.

Persons skilled in the art will appreciate that the above descriptions are merely preferred implementations or embodiments, but are not intended to limit the present disclosure. Any modification, equivalent and improvement within the sprit and principle of the present disclosure should be included in the scope of the present disclosure.

1. An encryption key comprising
a security module;
a first oscillation receiving unit configured to receive an oscillation signal transmitted through a medium;
a first oscillation transmission unit configured to transmit encryption information to the medium;
a first control unit coupled to the first oscillation receiving unit, the security module and the first oscillation transmission unit, wherein:
the first control unit transmits payment information to the security module in response to processing the oscillation signal received by the first oscillation receiving unit;
the security module outputs encrypted payment information; and
the first control unit decrypts the output of the security module and transmits the decrypted signal to the medium by the first oscillation transmission unit.

2. The encryption key according to claim 1, wherein the security module comprises:
a security chip coupled to the first control unit, for acquiring signature data and generating a control signal according to the signature data;
a storage device coupled to the security chip, for storing the signature data acquired by the security chip and providing required signature data for verifying; and
an identity authentication management module coupled to the first control unit, for managing the identity of a legitimate user of a mobile terminal and identifying a user's identity when the user is conducting a transaction.

3. The encryption key according to claim 2, wherein the first control unit comprises a controller configured to provide an interface connected to the security chip of the security module, analyze and respond to the control signal generated by the security chip, and control and process the transmitted and received information.

4. The encryption key according to claim 1, wherein the first oscillation transmission unit comprises an oscillation source for outputting oscillation wave under the control of the first control unit.

5. The encryption key according to claim 1, wherein the first oscillation receiving unit comprises a sensor and a signal processing unit, coupled to each other in sequence, wherein the sensor is configured to detect and receive the oscillation signal transmitted in the medium, and the signal processing unit is configured to output a digital signal after processing the oscillation signal.

6. The encryption key according to claim 5, wherein the signal processing unit comprises:
an A/D converter is configured to convert the oscillation signal transmitted in the medium and received by the sensor to a corresponding digital signal;
a demodulator is configured to demodulate the digital signal output by the A/D converter;
a low pass filter is configured to filter the output of the demodulator and acquire the non-decoded baseband digital signal; and
a decoder configured to output a digital signal after processing the baseband digital signal output from the low pass filter, wherein the A/D converter, the demodulator, the low pass filter and the decoder are connected in sequence.

7. The encryption key according to claim 1, wherein the oscillation signal is transmitted in the medium in the form of mechanical wave.

8. The encryption key according to claim 7, wherein the medium is one of liquid, solid, or air.

9. A security authentication system comprising an encryption key and a mobile terminal; the mobile terminal communicating with the encryption key by medium oscillation;
the encryption key comprises
a security module;
a first oscillation receiving unit configured to receive an oscillation signal transmitted through a medium;
a first oscillation transmission unit configured to transmit encryption information to the medium; and
a first control unit coupled to the first oscillation receiving unit, the security module and the first oscillation transmission unit, wherein
in response to processing the oscillation signal received by the first oscillation receiving unit, the first control unit transmits obtained payment information to the security module;
the security module outputs encrypted payment information; and
the first oscillation transmission unit transmits to the medium information obtained by the first control unit decrypting the output of the security module; and
the mobile terminal comprises a second control unit, a second oscillation receiving unit and a second oscillation transmission unit coupled to the second control unit respectively; the second oscillation receiving unit transmits signals with the first oscillation transmission unit by medium oscillation; the second transmission unit transmits signals with the first oscillation receiving unit by medium oscillation; wherein
the second control unit processes the payment information to obtain the oscillation signal, and transmits the oscillation signal to the medium by the second oscillation transmission unit; the second oscillation receiving unit receives the encryption information transmitted by the first oscillation transmission unit; and the second control unit processes the encryption information for encryption information transmission.

10. The security authentication system according to claim 9, wherein the mobile terminal is a cellphone or a PC.

11. The security authentication system according to claim 9, wherein the oscillation signal is transmitted in the medium in the form of mechanical wave.

12. The security authentication system according to claim 11, wherein the medium is one of liquid, solid, or air.

13. A method for security authentication for a mobile terminal, comprising:
in response to authenticating an encryption key, oscillating and initiating a request for receiving payment information;
obtaining an oscillation signal after receiving and processing a payment information instruction;
outputting the oscillation signal to a medium resided by the mobile terminal by oscillation, wherein the oscillating signal is received by
a first oscillation receiving unit in the encryption key, and the first control unit in the encryption key processes the oscillation signal and transmits the payment information to the security module, wherein the security module outputs the payment information after encrypting, and
in response to decrypting the information output from the security module, the first control unit in the encryption key sends a feedback on the decrypted information to a first oscillation transmission unit for outputting to the medium by oscillation;
receiving the encryption information from the first oscillation transmission unit and outputting the received encryption information to the second control unit; and
converting the received encryption information to the requested payment information.

14. The security authentication method according to claim 13, wherein the signal generated by oscillation is transmitted in the medium in the form of mechanical wave, wherein the mechanical wave is an acoustic wave with a frequency of 20 Hz˜20 KHz, or an ultrasonic wave with a frequency greater than 20 KHz.

15. The security authentication method according to claim 14, wherein the medium is one of liquid, solid, or air.

16. The security authentication method according to claim 14, wherein the mobile terminal is a cellphone or a PC.
